(19) United States
(12) Patent Application Publication
(10) Pub. No.: US 2002/0125693 A1
(43) Pub. Date: Sep. 12, 2002

(54) Hinging reinforced trim piece

(76) Inventors: Therial Levell Alsup, Dayton, OH (US); Derek N. Lampman, Kettering, OH (US); Charlie Scott Osman, Beavercreek, OH (US)

Correspondence Address: KATHRYN A. MARRA, DELPHI TECHNOLOGIES, INC., Legal Staff Mail Code: 480-414-420, P.O. Box 5052, Troy, MI, 48007-5052, US

(21) Appl. No.: 09/801,083

(22) Filed: Mar. 7, 2001

(51) Int. Cl. B60R 21/22

(52) U.S. Cl. 280/730.2; 280/728.2

(57) ABSTRACT

A trim piece for use within the interior of an automotive vehicle in covering relation to a structural support element with an expansible air bag cushion disposed between the trim piece and the structural support element. The trim piece is of a hingeable character including a relatively soft outer layer in substantially surrounding relation to an embedded deformable structural member such that it may be bent away during deployment of the air bag cushion so as to establish a controlled and substantially reproducible path of egress for the air bag cushion.

### TECHNICAL FIELD

The present invention relates to a trim piece for use in covering relation over an underlying structural element within a transportation vehicle, and more particularly to a pillar trim piece of hingeable character which facilitates the deployment of an inflatable air bag cushion from beneath the pillar trim piece upon the occurrence of an activating collision or roll-over event.

### BACKGROUND OF THE INVENTION

It is well known in motor vehicles to provide an air bag module for protecting a vehicle occupant. It is also known to provide an air bag module including an inflatable restraint cushion and an inflator for generating gas to inflate the cushion upon sensing predetermined vehicle conditions such as deceleration exceeding a certain predetermined value. It is further known to provide air bag modules including inflatable restraint cushions which are deployed from storage positions along the door frame of the vehicle in substantially curtain-like fashion between an occupant to be protected and the side portions of the vehicle so as to provide the occupant with a cushioning restraint during side impact or extended roll-over collision events. It is further known to store such curtain-like inflatable cushions at least partially along structural pillar elements extending away from the roof rail of the vehicle and to cover such storage positions with an aesthetic trim piece of substantially trough-like configuration. Such trim pieces are typically formed of relatively hard plastic having an aesthetic surface in color coordination with the interior of the vehicle.

The deployment of an inflatable air bag cushion from beneath a trim piece requires that the trim piece be forced away from the underlying structural element to permit the exit of the inflatable air bag cushion from its storage position between the trim piece and the structural element. In the past it has been found that such disengagement of the trim piece may be difficult to control due to the substantially rigid character of such plastic trim pieces. Moreover, hard plastic trim pieces may perform differently under different temperature conditions due to differences in flexibility characteristics. In this regard, it may be desirable to avoid the complete fracture of the trim piece during deployment of the inflatable air bag cushion over a broad range of temperatures so as to avoid the generation of loose debris within the vehicle during the latter stages of a collision event.

### SUMMARY OF THE INVENTION

This invention offers advantages and alternatives over the prior art by providing a trim piece for use within the interior of an automotive vehicle in covering relation to a structural support element with an expansible air bag cushion disposed between the trim piece and the structural support element. The trim piece is of a hingeable character such that it may be bent away from the underlying structural support element during deployment of the air bag cushion so as to establish a controlled and substantially reproducible path of egress for the air bag cushion.

According to one potentially preferred aspect of the present invention, these advantages may be accomplished in a trim element which substantially utilizes preexisting trough-like geometries of trim pieces as are presently used in covering relation to structural support pillars.

According to a further potentially preferred aspect of the present invention, the trim piece may include a relatively soft impact absorbing outer layer of flexible material in substantially surrounding relation to an embedded structural member.

According to yet a further potentially preferred aspect of the present invention, the trim piece may include a relatively soft outer covering layer in substantially surrounding relation to a stiffening inner structure of metal or the like. The stiffening inner member is preferably of a porous construction so as to permit the relatively soft surface material to permeate across the stiffening inner structure. The stiffening inner structure may include a hinge line of reduced thickness extending in a pattern at least partially along the length of the stiffening inner structure so as to define a living hinge within the trim piece. Integrated attachment structures such as male detent elements may project outward from the stiffening inner structure and through the outer covering layer for engagement with cooperating openings within the underlying structural element. The attachment elements are preferably located within an attachment zone on one side of the hinge line such that the portion of the stiffening inner structure on the other side of the hinge line is substantially freely rotatable away from the underlying structural element.

This invention provides a trim piece for use in covering a structural support element such as a structural pillar or roof rail of the vehicle frame. The trim piece can be bent away from the structural support element upon the application of a bending moment caused by the inflation and deployment of an air bag cushion housed between the trim piece and the structural support element. The trim piece may nonetheless be held in place at the support element by substantially static attachment points which are not subjected to substantial flexural bending. Prior to deployment of the inflatable air bag cushion, the relatively soft outer covering of the trim piece provides a degree of cushioning to an occupant which may be beneficial in some instances. Accordingly, the present invention is believed to provide useful advantages over the prior art.

### BRIEF DESCRIPTION OF THE DRAWINGS

The accompanying drawings, which are incorporated in and which constitute a part of this specification illustrate a potentially preferred embodiment of the present invention and, together with the general description of the invention given above and the detailed description set forth below, serve to explain the principles of the invention wherein:

FIG. 1 is a cut-away view of the interior of an automotive vehicle including an inflatable curtain-like air bag cushion stored along a portion of a pillar trim element;

FIG. 2 is a view similar to FIG. 1 following deployment of the inflatable curtain-like air bag cushion;

FIG. 3 is a perspective view of a pillar trim piece according to the present invention showing in hidden lines a substantially embedded stiffening structural support member;

FIG. 4 is a perspective view of a stiffening structural support member for use within the trim piece of FIG. 3;

FIG. 5 is a cross-section taken generally along line 5-5 in FIG. 4 illustrating the presence of an integrated attachment mechanism;

FIG. 6 is a cross-sectional view taken generally along line 6-6 in FIG. 3;

FIG. 7 is a cross-sectional view taken generally along line 7-7 in FIG. 3; and

FIG. 8 is a view similar to FIG. 6 illustrating the trim piece in a hinged configuration following deployment of an underlying air bag cushion.

While the invention has been illustrated and generally described above and will hereinafter be described in connection with certain potentially preferred embodiments and practices, it is to be understood that in no event is the invention limited to such illustrated and described embodiments and practices. On the contrary, it is intended that the present invention shall extend to all alternatives and modifications as may embrace the general principles of this invention within the true spirit and scope thereof.

### DESCRIPTION OF THE PREFERRED EMBODIMENT

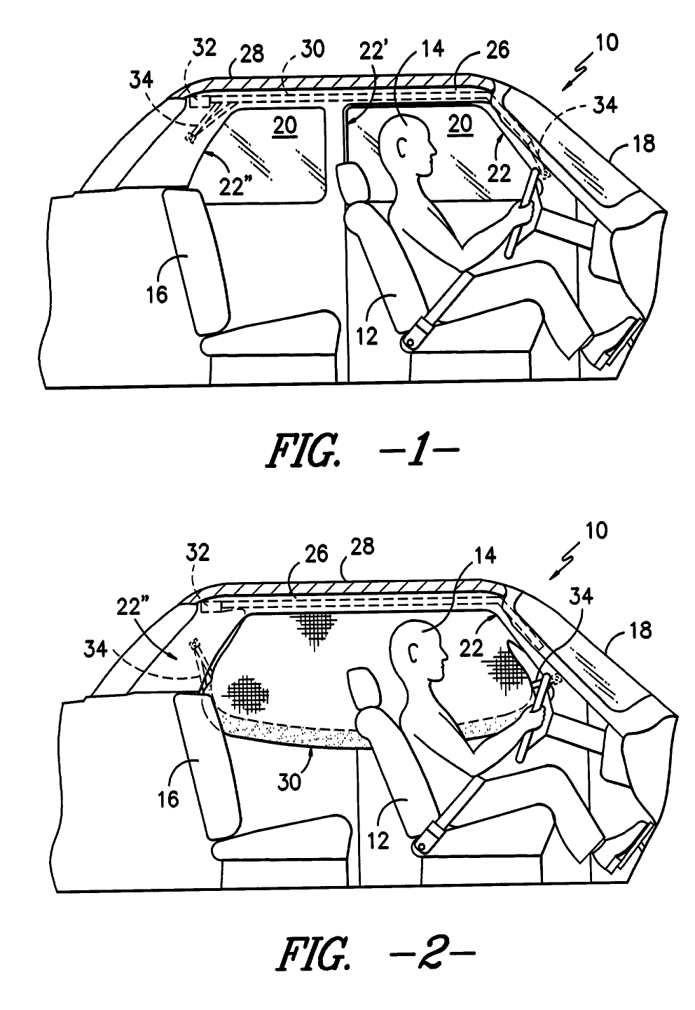

Turning now to the drawings wherein to the extent possible like reference numerals are utilized to designate like components throughout the various views, in FIG. 1 there is illustrated a vehicle 10 such as an automotive car, truck or the like. The vehicle 10 includes a front seat 12 which may be used to support a front seated occupant 14. The vehicle 10 may further include a rear seat 16 which may be used to support a rear occupant (not shown). However, it is to be appreciated that the present invention may likewise be utilized in a vehicle incorporating no rear seat as well as in vehicles incorporating three or more rows of seats. In addition, while the present invention will hereinafter be described in connection with use in an automotive vehicle, it is to be appreciated that the present invention may likewise be utilized in other transportation vehicles including by way of example only railroad cars and aircraft.

In order to provide visibility to the occupants of the vehicle 10, the vehicle 10 is provided with a windshield 18 as well as with one or more side windows 20. As shown, the side windows 20 are located generally adjacent to the seats 12, 16 to the sides of the occupants seated therein. The windows 20 are preferably bounded along their lateral edges by aesthetic trim elements 22, 22′, 22″ which cover a series of structural pillars extending downwardly from the structural roof rail 26 at the intersection between the roof 28 and the top of the windows 20. The roof rail 26 may likewise be covered by an aesthetic trim piece if desired.

As illustrated, it is contemplated that an air bag cushion 30 of substantially curtain-like configuration may be stored in rolled or folded relation along at least a portion of the roof rail 26 and beneath segments of one or more of the aesthetic trim elements 22, 22′, 22″.

According to the illustrated and potentially preferred practice, the air bag cushion 30 is preferably in fluid communication with a gas discharging inflator 32. As is well known to those of skill in the art, gas may be discharged from the inflator 32 and into the air bag cushion 30 to effect deployment of the air bag cushion 30. As illustrated, the inflatable air bag cushion 30 may also be attached to tethering elements 34 disposed beneath aesthetic trim elements 22, 22″ on either side of the region to be covered by the air bag cushion 30 following deployment.

Referring now to FIG. 2, the air bag cushion 30 is illustrated in an inflated deployed state substantially covering an area adjacent to the seats 12, 16. While the air bag cushion 30 is illustrated as extending in a deployed state substantially across the entire length of the vehicle interior adjacent to the seats 12, 16, it is likewise contemplated that the air bag cushion 30 may be deployed over a diminished region if desired such as the region between the so-called “A” pillar and the “B” covered respectively by the aesthetic trim elements 22, and 22′ or between the “B” pillar and the “C” pillar covered respectively by the aesthetic trim elements 22′ and 22″.

Regardless of the particular configuration or orientation of the air bag cushion 30, it is contemplated that a path of deployment is required from beneath one or more of the aesthetic trim elements 22, 22′, 22″ as well as from beneath any trim element as may cover the roof rail 26. That is, since the air bag cushion 30 is initially hidden beneath such trim elements, the inflated deployment of the air bag cushion 30 necessarily requires the air bag cushion 30 to exit from beneath at least portions of overlying aesthetic trim elements. The establishment of the requisite exit paths requires that the overlying trim elements be moved away from the underlying frame structure at the desired exit location.

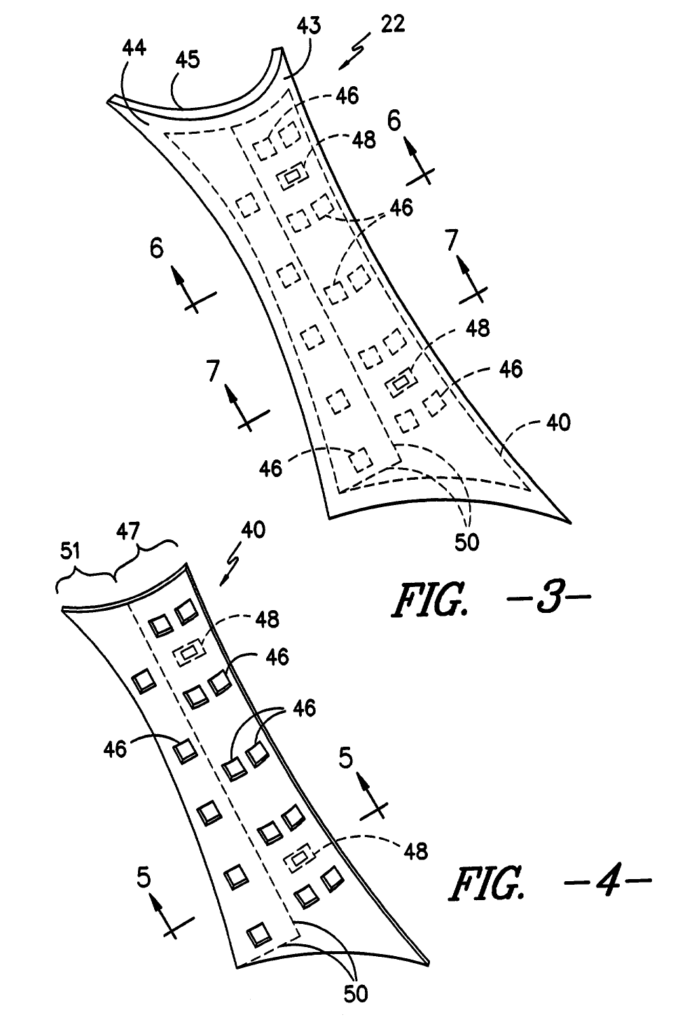

A potentially preferred construction for the aesthetic trim elements which facilitates the controlled opening of a deployment path is illustrated in FIG. 3 while the construction for aesthetic trim elements according to the present invention is illustrated and will hereafter be described in relation to the trim element 22 overlying the “A” pillar of the vehicle frame. It is to be understood that the features of such construction are likewise applicable to aesthetic trim elements 22′ overlying the “B” pillar and 22″″ overlying the “C” pillar respectively as well as any aesthetic trim element overlying the roof rail 26.

Referring simultaneously to FIGS. 3-7, an aesthetic trim element 22 in accordance with the present invention preferably includes a stiffening structural support member 40 having an outer covering 44 of relatively soft polymeric material. The structural support member 40 is preferably formed of a substantially rigid material such as metal or the like. While the structural support member 40 may be substantially flat, according to the illustrated and potentially preferred embodiment of the present invention, the structural support member 40 incorporates some degree of curvature across its surface so as to facilitate the establishment of a convex face 43 and a corresponding concave underside 45 across the trim element 22. As will be appreciated, such a concave underside 45 provides a storage area for the air bag cushion 30 prior to deployment. By way of example only, and not limitation, the structural support member 40 may be formed from stamped aluminum or light gauge steel.

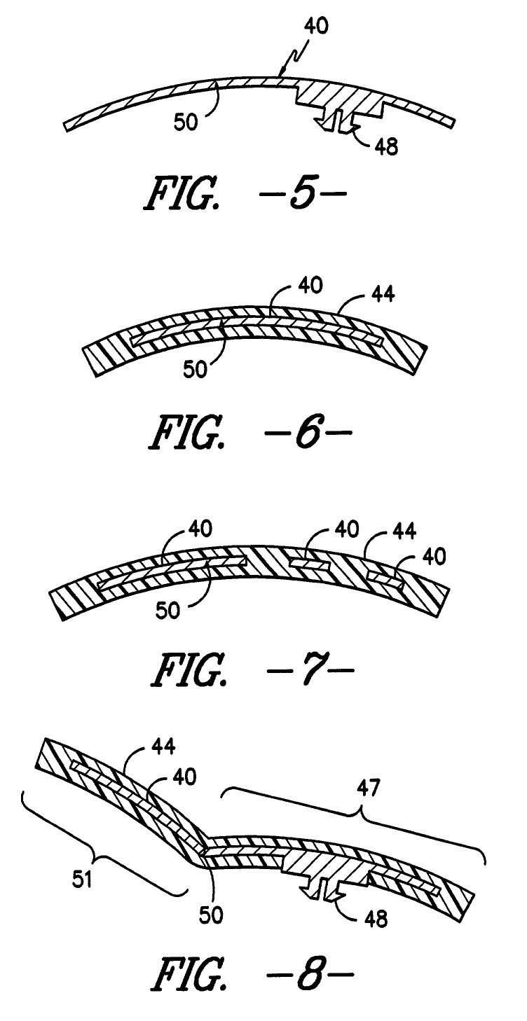

The outer covering 44 is preferably formed of a substantially flexible soft thermoplastic elastomer such as polyurethane, TPO or the like which is overmolded onto the structural support member 40. As best illustrated in FIG. 6, this overmolding preferably results in the structural support member 40 being substantially encased within the material forming the outer covering 44.

As best seen through reference to FIG. 4, the structural support member 40 preferably includes a number of openings 46 extending between opposing front and rear surfaces of the trim element 22. The openings 46 provide for flow through passage of the material forming the outer covering 44 across the structural support member 40 so as to promote complete overmolding coverage and secure adhesion of the structural support member 40 within the outer covering 44 (FIG. 7).

As best seen through reference to FIGS. 4 and 5, the structural support member 40 may include one or more integral outwardly projecting detent members 48 for attachment to the underlying frame structure. As will be appreciated, the location of such detent members 48 establishes a zone of attachment 47 for the trim elements to prevent complete separation away from the underlying support upon deployment of the air bag cushion 30. As illustrated, the detent members 48 are preferably arranged in spaced relation along the length of the structural support member on one side of an integral hinge 50 which is disposed between the zone of attachment 47 and a displaceable flap portion 51 extending along the desired location of egress for an underlying air bag cushion 30.

According to one potentially preferred practice, the hinge 50 is formed by thinning the structural support member 40 in a desired pattern along the length of the structural support member 40. It is contemplated that such thinning may be either in the form of a substantially continuous groove or may be in the form of intermittent slots of reduced thickness running in the desired pattern. In the event that the material forming the structural support member 40 is sufficiently malleable, it is also contemplated that the desired hinging action may be achieved without the introduction of any preferentially thinned integral hinge 50. It is also contemplated that the integral detent members 48 may be eliminated and replaced with traditional screws or other fastening devices extending through the structural support member within the desired zone of attachment 47.

Due to the presence of the structural support member 40 and the fact that attachment to the underlying support member is carried out within a zone of attachment 47 extending on one side of a hinge line 50 so as to leave a substantially unattached zone corresponding to a displaceable flap portion 51 on the other side of the hinge line 50, the displaceable flap portion 51 may be bent freely away from the underlying pillar or other support surface upon the introduction of a moment generating force. Thus, by arranging the trim elements of the present invention within the vehicle 10 such that the displaceable flap portions 51 are aligned adjacent to the areas to be covered by the air bag cushion 30, the inflation of the air bag cushion 30 beneath the trim element gives rise to a moment generating force causing a path of egress to be opened for the inflating air bag cushion 30 as the flap portion 51 is bent away from the underlying frame (FIG. 8).

The substantially flexible nature of the outer covering 44 permits such bending to take place without potentially undesirable fracture of the outer covering 44. Moreover, despite the bending away of the flap portion 51, the trim element is nonetheless maintained in place at the zone of attachment 47 throughout the deployment process. Such continued attachment prevents the potentially undesirable complete displacement of the trim element.

It is to be understood that while the present invention has been illustrated and described in relation to certain potentially preferred embodiments, constructions, and procedures, that such embodiments, constructions, and procedures are illustrative only and that the present invention is in no event to be limited thereto. Rather, it is contemplated that modifications and variations embodying the principles of this invention will no doubt occur to those of skill in the art. It is thus contemplated and intended that the present invention shall extend to all such modifications and variations as may incorporate the broad aspects of the invention within the full spirit and scope of the appended claims and all equivalents thereto.

1. A trim element for use in a transportation vehicle in covering relation to an inflatable air bag cushion stored between the trim element and an underlying support surface wherein the air bag cushion is inflated for deployment from beneath the trim element and across a surface to be covered by the air bag cushion during a collision or roll-over event, the trim element comprising: a deformable structural support member and a covering of substantially flexible polymeric material disposed in covering relation over the structural support member, the structural support member including a zone of attachment for anchoring attachment to the underlying support surface, the structural support member further including a displaceable flap portion for disposition between the zone of attachment and the surface to be covered by the air bag cushion, the displaceable flap portion and covering polymeric material being moveable in substantially hinge-like fashion away from the air bag cushion as the air bag cushion is inflated such that an opening is established for egress of the air bag cushion from beneath the trim element while the trim element remains anchored to the underlying support surface at the zone of attachment.

2. The invention as recited in claim 1, wherein the structural support member is substantially encased within the flexible polymeric material.

3. The invention as recited in claim 1, wherein the structural support member includes one or more integral detent members extending away from the zone of attachment for attachment to the underlying support member.

4. The invention as recited in claim 1, wherein the structural support member comprises a metallic material.

5. The invention as recited in claim 4, wherein the metallic material is selected from the group consisting of aluminum and steel.

6. The invention as recited in claim 1, wherein the substantially flexible polymeric material comprises a thermoplastic elastomer.

7. The invention as recited in claim 1, wherein the structural support member comprises a plurality of openings projecting through the structural support member and wherein the substantially flexible polymeric material extends in filling relation within said openings between opposing surfaces of the structural support member.

8. The invention as recited in claim 7, wherein said openings project through the zone of attachment and through the flap portion of the structural support member.

9. The invention as recited in claim 1, wherein the structural support member is preferentially thinned along an integral hinge disposed substantially at the intersection between the zone of attachment and the displaceable flap portion such that the displaceable flap portion rotates around the integral hinge.

10. The invention as recited in claim 9, wherein the integral hinge comprises a slot extending along a desired hinging pattern.

11. The invention as recited in claim 9, wherein the integral hinge comprises a plurality of slots extending in end to end relationship along a desired hinging pattern.

12. A trim element for use in a transportation vehicle in covering relation to an inflatable air bag cushion stored between the trim element and an underlying support surface wherein the air bag cushion is inflated for deployment from beneath the trim element and across a surface to be covered by the air bag cushion during a collision or roll-over event, the trim element comprising: a deformable structural support member substantially encased within a covering of substantially flexible polymeric material, the structural support member including a zone of attachment for anchoring attachment to the underlying support surface, a displaceable flap portion for disposition between the zone of attachment and the surface to be covered by the air bag cushion, and an integral hinge disposed between the displaceable flap portion and the zone of attachment such that the displaceable flap portion and surrounding polymeric material is moveable in substantially hinge-like fashion away from the air bag cushion as the air bag cushion is inflated such that an opening is established adjacent to the surface to be covered for egress of the air bag cushion from beneath the trim element while the trim element remains anchored to the underlying support surface at the zone of attachment.

13. The invention as recited in claim 12, wherein the structural support member includes one or more integral detent members projecting away from the zone of attachment and through the covering of polymeric material for attachment to the underlying support member.

14. The invention as recited in claim 12, wherein the structural support member comprises a metallic material.

15. The invention as recited in claim 14, wherein the metallic material is selected from the group consisting of aluminum and steel.

16. The invention as recited in claim 12, wherein the substantially flexible polymeric material comprises a thermoplastic elastomer.

17. The invention as recited in claim 12, wherein the structural support member comprises a plurality of openings projecting through the structural support member and wherein the substantially flexible polymeric material extends in filling relation within said openings between opposing surfaces of the structural support member.

18. The invention as recited in claim 17, wherein said openings project through the zone of attachment and through the flap portion of the structural support member.

19. A trim element for use in a transportation vehicle in covering relation to an inflatable air bag cushion stored between the trim element and an underlying support surface wherein the air bag cushion is inflated for deployment from beneath the trim element and across a surface to be covered by the air bag cushion during a collision or roll-over event, the trim element comprising: a malleable structural support member substantially encased within a covering of substantially flexible polymeric material, the structural support member including a zone of attachment for anchoring attachment to the underlying support surface, a displaceable flap portion for disposition between the zone of attachment and the surface to be covered by the air bag cushion, and an integral hinge disposed between the displaceable flap portion and the zone of attachment such that the displaceable flap portion and surrounding polymeric material is moveable in substantially hinge-like fashion away from the air bag cushion as the air bag cushion is inflated such that an opening is established adjacent to the surface to be covered for egress of the air bag cushion from beneath the trim element while the trim element remains anchored to the underlying support surface at the zone of attachment, the structural support member including a plurality of openings projecting through the structural support member such that the substantially flexible polymeric material extends in filling relation within said openings between opposing surfaces of the structural support member, the structural support member further including a plurality of detent members projecting away from the zone of attachment and through the covering of polymeric material for attachment to the underlying support member.
